(19) United States
(12) Patent Application Publication
(10) Pub. No.: US 2016/0258319 A1
(43) Pub. Date: Sep. 8, 2016

(54) COMPRESSED CHOPPED FIBER COMPOSITE INLET GUIDE VANE

(71) Applicant: UNITED TECHNOLOGIES CORPORATION, Farmington, CT (US)

(72) Inventors: Matthew A. Turner, Wallingford, CT (US); Andrew G. Alarcon, Manchester, CT (US); Shari L. Bugaj, Haddam, CT (US)

(73) Assignee: UNITED TECHNOLOGIES CORPORATION

(21) Appl. No.: 14/546,752

(22) Filed: Nov. 18, 2014

Related U.S. Application Data
(60) Provisional application No. 61/934,345, filed on Jan. 31, 2014.

(51) Int. Cl. F01D 25/00; F01D 9/04

(52) U.S. Cl. CPC F01D 25/005; F01D 9/041; F05D 2220/32; F05D 2300/436; F05D 2300/434; F05D 2300/6031

(57) ABSTRACT

The present disclosure relates generally to the field of guide vanes for gas turbine engines. More specifically, the present disclosure relates to a compressed chopped fiber composite inlet guide vane for a gas turbine engine.

### CROSS REFERENCE TO RELATED APPLICATIONS

The present application is related to, and claims the priority benefit of, U.S. Provisional Patent Application Ser. No. 61/934,345 filed Jan. 31, 2014, the contents of which are hereby incorporated in their entirety into the present disclosure.

### TECHNICAL FIELD OF THE DISCLOSED EMBODIMENTS

The present disclosure is generally related to gas turbine engines and, more specifically, to a compressed chopped fiber composite inlet guide vane for a gas turbine engine.

### BACKGROUND OF THE DISCLOSED EMBODIMENTS

A gas turbine engine compressor typically includes inlet guide vanes followed by a row, or stage of compressor rotor blades. During operation, air flows through the inlet guide vane and is sequentially compressed by the compressor stages.

Inlet guide vanes are used to meter the amount of airflow through the compressor. The vanes are arranged in an annular duct and are rotated in synchronization to change the open area of the duct, allowing more or less air to pass therethrough. Generally, inlet guide vanes are constructed of strong, durable metals, such as aluminum. However, use of such metals may increase cost of the overall engine.

Improvements in inlet guide vanes are therefore needed in the art.

### SUMMARY OF THE DISCLOSED EMBODIMENTS

In one aspect, an inlet guide vane for a gas turbine engine is disclosed, the inlet guide vane including: an airfoil composed of a compressed chopped fiber composite. The inlet guide vane further includes a trunnion and a spindle portion operatively coupled to the airfoil. The trunnion and the spindle portion are composed of the compressed chopped fiber composite. The compressed chopped fiber composite includes a carbon-fiber, glass-fiber or Boron-fiber that is chopped into lengths of approximately 0.5-2.0″ long and pre-impregnated with a matrix material, such as an epoxy or other matrix resin system. The matrix material is selected from the group consisting of epoxy and resin. The epoxy includes a carbon epoxy. The compressed chopped fiber composite includes a polyether ether ketone (PEEK), polyetherimide (PEI), polyimide (PI), or other thermoplastic.

In another aspect, a gas turbine engine is disclosed, including: a plurality of inlet guide vanes, each of the inlet guide vanes including an airfoil composed of a compressed chopped fiber composite. Each of the inlet guide vanes further includes a trunnion and a spindle portion operatively coupled to the airfoil. The trunnion and the spindle portion are composed of the compressed chopped fiber composite. The compressed chopped fiber composite includes a carbon-fiber, glass-fiber or Boron-fiber that is chopped into lengths of approximately 0.5-2.0″ long and pre-impregnated with a matrix material, such as an epoxy or other matrix resin system. The compressed chopped fiber composite includes a carbon epoxy. The compressed chopped fiber composite includes a polyether ether ketone (PEEK), polyetherimide (PEI), polyimide (PI), or other thermoplastic.

Other embodiments are also disclosed.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic cross-sectional view of a gas turbine engine; and

FIG. 2 is a perspective view of an inlet guide vane in an embodiment.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

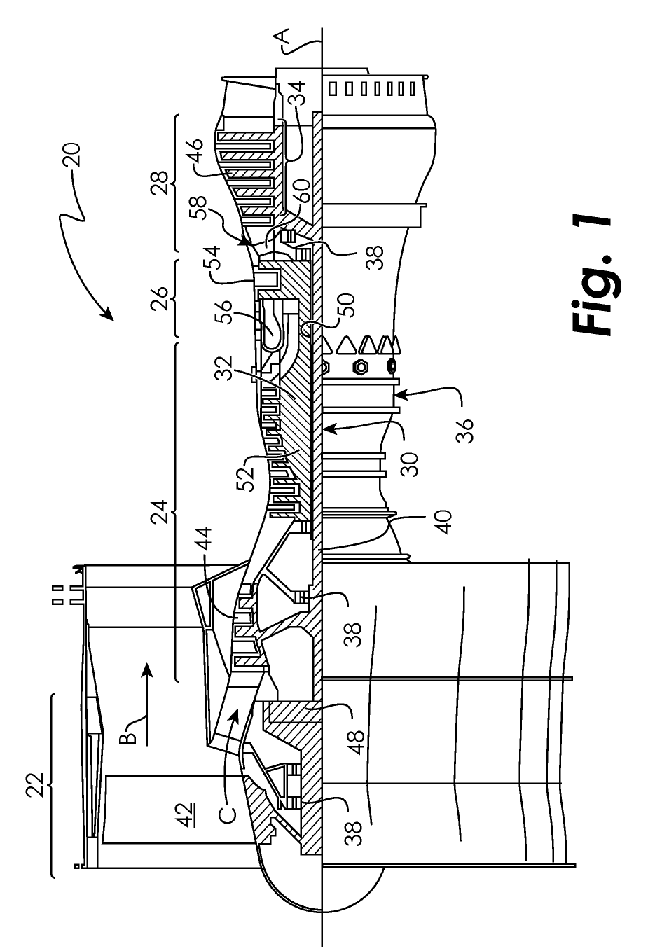

FIG. 1 schematically illustrates a typical architecture for a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded through the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft./sec divided by an industry standard temperature correction of [(Tram ° R)/(518.7° R)]^{0.5}. The “Low corrected fan tip speed” as disclosed herein according to one non-limiting embodiment is less than about 1150 ft./second.

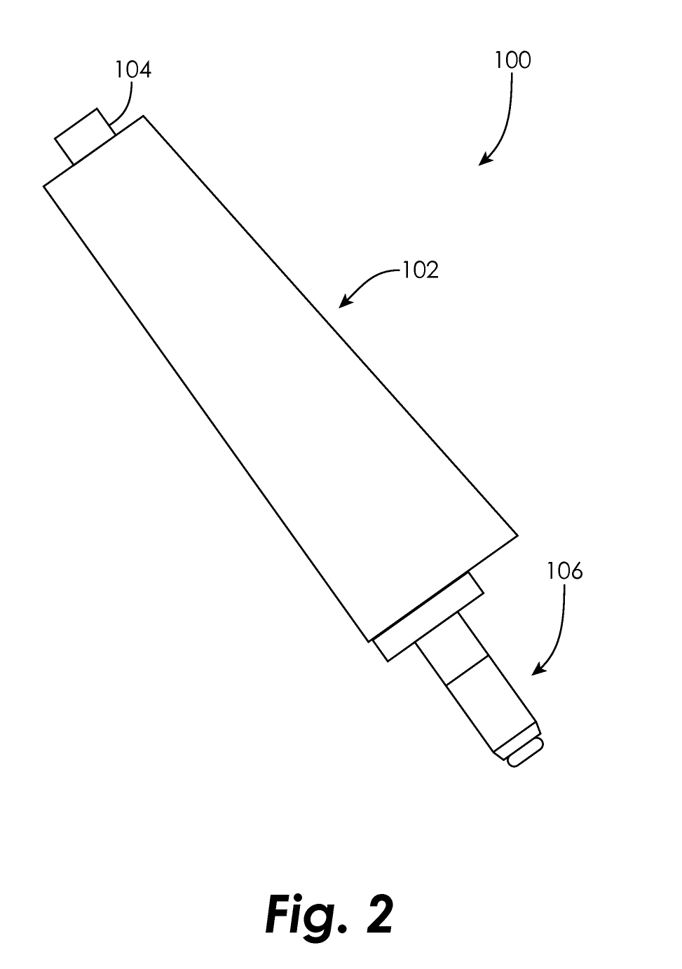

A perspective view of an inlet guide vane 100 is illustrated in FIG. 2. The inlet guide vane 100 includes an airfoil 102. The inlet guide vane 100 further includes a trunnion 104 and a spindle portion 106 operatively coupled to the airfoil 102. A plurality of inlet guide vanes 100 are disposed around the centerline axis in front of the compressor section 24. The inlet guide vane 100 is formed from a compressed chopped fiber composite. For example, in some embodiments the compressed chopped fiber composite comprises a carbon-fiber, glass-fiber or Boron-fiber that is chopped into lengths of approximately 0.5-2.0″ long and pre-impregnated with a matrix material, such as an epoxy or other matrix resin system. In one embodiment, the compressed chopped fiber composite includes a carbon epoxy, for example the Hexcel® HexMC® carbon fiber epoxy resin molding material. In other embodiments, the compressed chopped fiber composite includes a polyether ether ketone (PEEK), polyetherimide (PEI), polyimide (PI), or other thermoplastic, to name just a few non-limiting examples. This is a typical, well-known inlet guide vane construction; however, other constructions are known in the art. It will be appreciated that any desired manufacturing techniques may be used in manufacturing the plurality of inlet guide vanes 100 using a compressed chopped fiber composite.

Constructing the plurality of inlet guide vanes from a compressed chopped fiber composite allows for greater design flexibility to construct complex shapes and easily alter cross-section designs as compressed chopped fiber composite is less sensitive to defects than many other materials. Additionally, compressed chopped fiber composite may be a lighter material, compared to aluminum, thus, providing a lighter and more cost effective inlet guide vane 100.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. An inlet guide vane for a gas turbine engine comprising:
an airfoil portion, wherein the airfoil portion is composed of a compressed chopped fiber composite.

2. The inlet guide vane of claim 1, further comprising a trunnion and a spindle portion operatively coupled to the airfoil portion.

3. The inlet guide vane of claim 2, wherein the trunnion and the spindle portion are composed of the compressed chopped fiber composite.

4. The inlet guide vane of claim 1, wherein the compressed chopped fiber composite comprises a material selected from the group consisting of: carbon-fiber, glass-fiber or Boron-fiber.

5. The inlet guide vane of claim 1, wherein the compressed chopped fiber composite comprises a fiber that is chopped into lengths of approximately 0.5″ to approximately 2″ long.

6. The inlet guide vane of claim 1, wherein the compressed chopped fiber composite comprises a fiber that is pre-impregnated with a matrix material.

7. The inlet guide vane of claim 6, wherein the matrix material is selected from the group consisting of epoxy and resin.

8. The inlet guide vane of claim 7, wherein the epoxy comprises a carbon epoxy.

9. The inlet guide vane of claim 1, wherein the compressed chopped fiber composite comprises a material selected from the group consisting of: polyether ether ketone (PEEK), polyetherimide (PEI), and polyimide (PI).

10. A gas turbine engine comprising:
a plurality of inlet guide vanes, each inlet guide vane comprising:
an airfoil, wherein the airfoil is composed of a compressed chopped fiber composite.

11. The gas turbine engine of claim 10, wherein each of the inlet guide vanes further comprises a trunnion and a spindle portion operatively coupled to the airfoil.

12. The gas turbine engine of claim 11, wherein the trunnion and the spindle portion are composed of the compressed chopped fiber composite.

13. The gas turbine engine of claim 10, wherein the compressed chopped fiber composite comprises a material selected from the group consisting of: carbon-fiber, glass-fiber or Boron-fiber.

14. The gas turbine engine of claim 10, wherein the compressed chopped fiber composite comprises a fiber that is chopped into lengths of approximately 0.5″ to approximately 2″ long.

15. The gas turbine engine of claim 10, wherein the compressed chopped fiber composite comprises a fiber that is pre-impregnated with a matrix material.

16. The gas turbine engine of claim 15, wherein the matrix material is selected from the group consisting of epoxy and resin.

17. The gas turbine engine of claim 16, wherein the epoxy comprises a carbon epoxy.

18. The gas turbine engine of claim 10, wherein the compressed chopped fiber composite comprises a material selected from the group consisting of: polyether ether ketone (PEEK), polyetherimide (PEI), and polyimide (PI).
